(19) United States
(12) Patent Application Publication
(10) Pub. No.: US 2012/0069194 A1
(43) Pub. Date: Mar. 22, 2012

(54) COMMUNICATION APPARATUS, TELEVISION RECEIVER, VIDEO SIGNAL RECORDING APPARATUS, AND COMMUNICATION METHOD

(76) Inventors: Yoshifumi Sakata, Osaka (JP); Seiji Kubo, Osaka (JP); Taku Matsuda, Nara (JP)

(21) Appl. No.: 13/146,763

(22) PCT Filed: Nov. 17, 2010
(86) PCT No.: PCT/JP2010/006741

§ 371 Date: Jul. 28, 2011

(30) Foreign Application Priority Data
Mar. 26, 2010 (JP) 2010-071963

(51) Int. Cl. H04N 17/04; H04N 5/94; H04L 1/00

(52) U.S. Cl. 348/177; 370/248; 386/263; 386/E05.035

(57) ABSTRACT

A communication apparatus is provided which is capable of easily detecting an error that is difficult to detect, in a communication cable. The communication apparatus performs communication using a communication cable including plural sets of paired wires each of which has two core wires, and includes: an interface unit (310) connectable to the communication cable; a measuring unit (320) which obtains measurement values by measuring a value indicating a state of each set of the paired wires included in the communication cable connected to the interface unit (310); and an error information output unit (330) which outputs error information indicating an error in the communication cable when the measured values obtained by the measuring unit (320) are substantially different.

### TECHNICAL FIELD

The present invention relates to a communication apparatus for communication using a communication cable including plural sets of paired wires.

### BACKGROUND ART

Currently, twisted pair cables (also referred to as TP cables) are commonly used in the Internet and local area networks (LAN). The twisted pair cable is an example of a communication cable in which core wires provided with insulating coating are twisted in pairs and the pairs (twisted pairs) are bundled.

The twisted pair cables are less likely to be affected by noise compared to parallel conducting wires. In addition, stable impedance can be obtained with the twisted pair cables. In addition, the twisted pair cables have an advantageous effect of suppressing crosstalk caused by electromagnetic induction generated by a signal that passes through other conducting wires.

In order to take advantage of the twisted pair cables, it is necessary that each of the core wires is correctly coupled with a corresponding one of the connectors. In some cases, however, a user or an equipment installer inadvertently prepares a twisted pair cable (hereinafter referred to as a LAN cable) for Ethernet® that uses an RJ45 connector (eight-wire system modular jack used for ISDN or 10BASE-T) with incorrect wiring. More specifically, a user or a service provider inadvertently produces, in some cases, a LAN cable 600 including a split pair as shown in FIG. 8B, instead of a LAN cable 500 with correct wiring as shown in FIG. 8A.

Here, a split pair is an erroneous wiring where two core wires that need to be twisted together are not twisted together. When such a mispairing is included in the LAN cable, communication is basically possible because the conducting wires are electrically normally connected; however, the advantageous effect of noise reduction obtained by twisting cannot be obtained.

FIG. 8A is a configuration diagram which shows a conventional packet communication apparatus to which a LAN cable with correct wiring is in connected. FIG. 8B is a configuration diagram which shows a conventional packet communication apparatus to which a LAN cable with erroneous wiring is connected. It is to be noted that the correct (normal) wiring here refers to a state where each of the core wires is electrically connected and properly arranged. On the other hand, the incorrect (abnormal) wiring includes not only a state where each of the core wires is not electrically connected but also a state where each of the core wires is not properly arranged.

The conventional packet communication apparatus 400 shown in FIG. 8A and FIG. 8B includes: an IF unit (interface unit) 410; a packet transmitting and receiving unit 420; and a communication unit 440. Furthermore, the packet transmitting and receiving unit 420 includes a transmitting unit 421 and a receiving unit 422.

The LAN cable 500 includes a connector 510 and a connector 520 at the ends. More specifically, the LAN cable 500 includes a LAN cable body and two connectors. The IF unit 410 is connected to the connector 510 of the LAN cable 500. The packet communication apparatus 400 carries out packet communication with an external apparatus (not illustrated) via the LAN cable 500.

As shown in FIG. 8A, a pair A is connected to a core wire L1 and a core wire L2 which form a twisted pair. In addition, a pair B is connected to a core wire L3 and a core wire L6 which form a twisted pair. As described above, each of the pair A, the pair B, a pair C, and a pair D is a twisted pair. Therefore, normal wiring is established in the LAN cable 500.

On the other hand, in FIG. 8B, the pair A is connected to a core wire N1 and a core wire N2 which form a twisted pair. In addition, a pair D is connected to a core wire N7 and a core wire N8 which form a twisted pair. Thus, each of the pair A and the pair D is a twisted pair.

However, a pair B is connected to a core wire N3 and a core wire N6 in which do not form a twisted pair. Furthermore, a pair C is connected to a core wire N4 and a core wire N5 which do not form a twisted pair. Thus, neither of the pair B and the pair C is a twisted pair. That means that not all of the pairs are twisted pairs. Therefore, the LAN cable 600 is a LAN cable including a split pair, which is different from normal wiring.

Such a wiring error often occurs due to miscalculation by a user or a service provider to connect two core wires that form a twisted pair to pins positioned side by side in a connector 610 and a connector 620.

The noise reduction effect produced by twisting cannot be obtained with a LAN cable including a split pair, which is not normal wiring, such as the LAN cable 600. Since a communication error occurs when noise is high, it is highly desired not to use such a LAN cable.

In view of the above, it is necessary to determine whether or not wiring is normally established in the LAN cable used for communication. PTL 1 discloses a method and apparatus for determining connection of twisted pair cables, in other words, for detecting a split pair, using a crosstalk detection function.

In addition, PTL 2 discloses a network connection device and a network connection notification method that enable even a user who does not have much technical knowledge to accurately obtain information necessary for connecting to a network, such as linking-up.

### CITATION LIST

### Patent Literature

### [PTL 1]

Japanese Unexamined Patent Application Publication No. 2002-078130

### [PTL 2]

Japanese Unexamined Patent Application Publication No. 2009-111800

### SUMMARY OF INVENTION

### Technical Problem

However, the detection method disclosed by PTL1 uses the crosstalk detection function. Thus, this detection method has a problem that a split pair cannot be detected in a communication apparatus which does not have the crosstalk detection function.

A chip for converting a logic signal into an actual electric signal is used in communication using a LAN cable. Such a chip is called a PHY chip. Currently, a PHY chip having the crosstalk detection function is also available. However, not all the PHY chips have the crosstalk detection function. In such a circumstance, it is desired to detect a split pair using a function more commonly held by many PHY chips.

In addition, according to the network connection device and the network connection notification method disclosed by PTL 2, a user can accurately comprehend settings necessary for communication, such as setting for linking-up or an IP address. However, even when the LAN cable in use is a LAN cable including a split pair, there is no mechanism to detect the split pair.

Thus, with the device and method disclosed by PTL 2, the user cannot easily recognize that normal communication is disabled due to use of a LAN cable including a split pair.

More specifically, when the LAN cable in use includes a split pair, there is mispairing in the LAN cable, but the conducting wires are electrically normally connected. Thus, communication is basically possible. However, the noise reduction effect produced by twisting cannot be obtained. Therefore, communication is disabled when noise is high. Thus, it is difficult for a user who does not have much knowledge in networking to understand what is the cause of a communication error.

In view of the above, the present invention aims to provide a communication apparatus that enables easy detection of an error which is difficult to detect in a communication cable.

### Solution to Problem

In order to solve the above-stated problems, the communication apparatus according to an aspect of the present invention is a communication apparatus for communication using a communication cable including plural sets of paired wires, the communication apparatus comprising: an interface unit connectable to the communication cable; a measuring unit configured to measure a value indicating a state of each set of the paired wires included in the communication cable connected to the interface unit, to obtain measured values; and an error information output unit configured to output error information indicating an error in the communication cable when the measured values obtained by the measuring unit are substantially different.

With this, the communication apparatus can detect a difference between measured values, which is caused by an effect of noise and the like. Thus, the communication apparatus can easily detect an error that is difficult to detect, in the communication cable. Therefore, communication troubles accompanied with an error in the communication cable is reduced.

In addition, the communication apparatus may further comprises a packet transmitting and receiving unit configured to transmit and receive a packet via the interface unit, wherein the measuring unit is included in the packet transmitting and receiving unit.

With this, the communication apparatus can detect an error in the communication cable, using a measurement function held by the packet transmitting and receiving unit.

Furthermore, the measuring unit may measure, as the value indicating the state, a value indicating a length of each set of the paired wires, to obtain the measured values.

With this, the communication apparatus can detect an error in the communication cable, using a function to measure the length of the set of paired wires.

Furthermore, the measuring unit may measure, as the value indicating the state, a value indicating a length of time from transmitting an incident wave to receiving a reflected wave, for each set of the paired wires, to obtain the measured values.

With this, the communication apparatus can detect an error in the communication cable, using a function to measure reflection.

Furthermore, when the measured values obtained by the measuring unit are substantially different, the error information output unit may output the error information indicating that the communication cable includes a split pair which is an erroneous wiring in which two core wires that need to be twisted together are not twisted together.

With this, an error in the communication cable is detected as an error of a split pair. When measured values are different from each other, it is highly likely that the communication cable includes a split pair. Therefore, error information with higher accuracy is outputted.

Furthermore, the error information output unit may output the error information when a difference between the measured values obtained by the measuring unit falls outside a range of a measurement error of the measuring unit.

With this, the range in which measured values are regarded as substantially the same is appropriately determined.

Furthermore, the measuring unit may measure more than once the value indicating the state and calculate one of an average value, a median, and a mode of measurement results for each set of the paired wires, to obtain the measured values.

With this, an error in the communication cable is detected with higher accuracy.

Furthermore, the packet transmitting and receiving unit may transmit and receive a packet to and from an external apparatus via the interface unit when the measured values obtained by the measuring unit are substantially the same.

With this, communication with an external apparatus is restricted in an unstable state.

Furthermore, the error information output unit may output the error information when a difference or a ratio between a maximum value and a minimum value among the measured values obtained by the measuring unit falls outside a predetermined range.

With this, whether or not the measured values are substantially the same is appropriately determined.

Furthermore, the television receiver according to an aspect of the present invention may be a television receiver connectable to a network and comprising: the communication apparatus and a display unit configured to display a video signal received by the communication apparatus.

With this, the communication apparatus according to an aspect of the present invention is embodied as a television receiver capable of detecting an error in the communication cable, which is difficult to detect.

Furthermore, the video signal recording apparatus according to an aspect of the present invention may be a video signal recording apparatus connectable to a network and comprising: the communication apparatus; and a writing unit configured to write onto a recording medium, a video signal received by the communication apparatus.

With this, the communication apparatus according to an aspect of the present invention is embodied as a video signal recording apparatus capable of detecting an error in the communication cable, which is difficult to detect.

Furthermore, the communication method according to an aspect of the present invention may be a communication method for communication using a communication cable performed by a communication apparatus including an interface unit connectable to the communication cable including plural sets of paired wires, the communication method comprising: measuring a value indicating a state of each set of the paired wires included in the communication cable connected to the interface unit, to obtain measured values; and outputting error information indicating an error in the communication cable when the measured values obtained in the measuring are substantially different.

With this, the communication apparatus according to an aspect of the present invention is embodied as a communication method.

Furthermore, the program according to an aspect of the present invention may be a program causing a communication apparatus including an interface unit connectable to a communication cable including plural sets of paired wires, to execute: measuring a value indicating a state of each set of the paired wires included in the communication cable connected to the interface unit, to obtain measured values; and outputting error information indicating an error in the communication cable when the measured values obtained in the measuring are substantially different.

With this, the communication method according to an aspect of the present invention is embodied as a program.

Furthermore, the integrated circuit according to an aspect of the present invention may be an integrated circuit mounted on a communication apparatus including an interface unit connectable to a communication cable that includes plural sets of paired wires and a measuring unit that measures a value indicating a state of each set of the paired wires included in the communication cable connected to the interface unit, to obtain measured values; the integrated circuit comprising an error information output unit configured to output error information indicating an error in the communication cable when the measured values obtained by the measuring unit are substantially different.

With this, the communication apparatus according to an aspect of the present invention is embodied as an integrated circuit.

### Advantageous Effects of Invention

According to the present invention, an error in a communication cable, which is difficult to detect, can be detected. Therefore, communication troubles accompanied with an error in the communication cable is reduced.

### BRIEF DESCRIPTION OF DRAWINGS

FIG. 1 is a configuration diagram which shows a packet communication apparatus according to Embodiment 1.

FIG. 2 is a conceptual diagram which shows plural sets of paired wires according to Embodiment 1.

FIG. 3 is a flowchart which shows processing performed by the packet communication apparatus according to Embodiment 1.

FIG. 4A is a diagram which shows a first example of a measurement result according to Embodiment 1.

FIG. 4B is a diagram which shows a second example of a measurement result according to Embodiment 1.

FIG. 5A is a conceptual diagram which shows a measurement in a normal state according to Embodiment 1.

FIG. 5B is a conceptual diagram which shows a measurement in an abnormal state according to Embodiment 1.

FIG. 6A is a configuration diagram which shows a communication apparatus according to Embodiment 3.

FIG. 6B is a flowchart which shows processing performed by the communication apparatus according to Embodiment 3.

FIG. 7 is a conceptual diagram which shows a television receiver and a video signal recording apparatus according to Embodiment 4.

FIG. 8A is a configuration diagram which shows a conventional packet communication apparatus in which a LAN cable is connected with correct wiring.

FIG. 8B is a configuration diagram which shows a conventional packet communication apparatus to which a LAN cable with erroneous wiring is connected.

### DESCRIPTION OF EMBODIMENTS

The following is a description of embodiments according to the present invention, with reference to the drawings.

### Embodiment 1

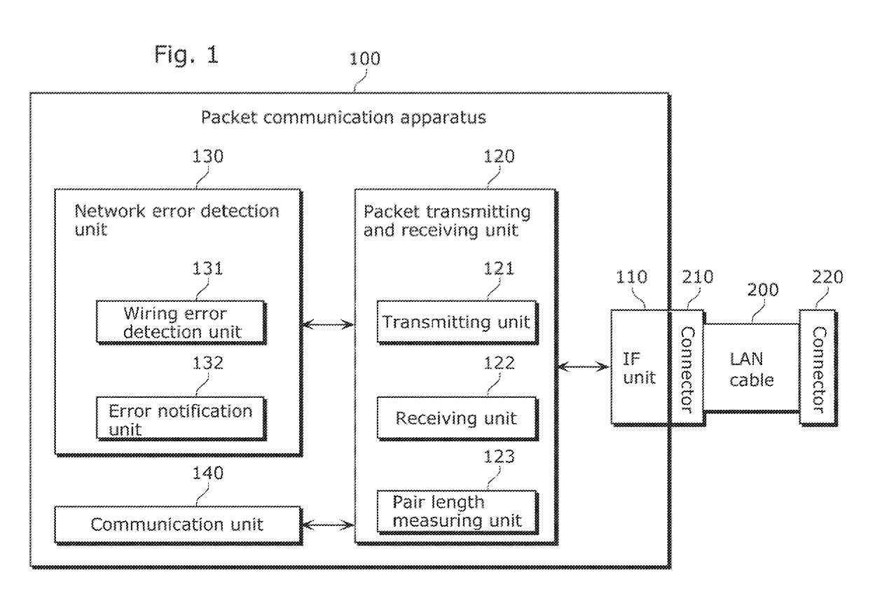

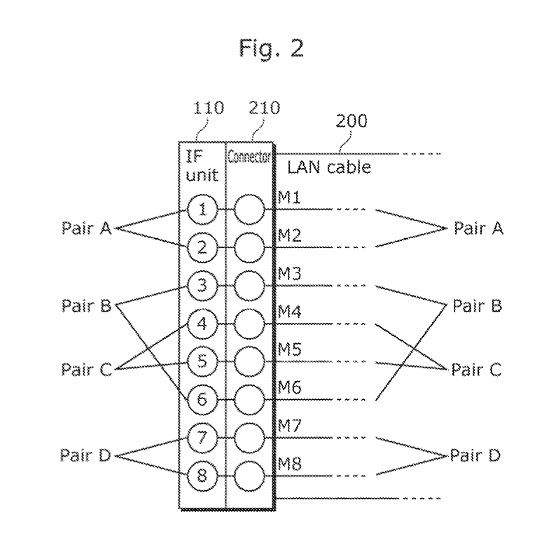

FIG. 1 is a configuration diagram which shows a packet communication apparatus according to Embodiment 1. A packet communication apparatus 100 shown in FIG. 1 is an example of a communication apparatus for communication using a communication cable including plural sets of paired wires each of which has two core wires. The alignment of core wires at the end of the communication cable including the core wires determines pairing of the core wires. The determination of pairing of core wires will be described later with reference to FIG. 2.

The packet communication apparatuses 100 includes: an IF unit (interface unit) 110; a packet transmitting and receiving unit 120; a network error detection unit 130; and a communication unit 140. Furthermore, the packet transmitting and receiving unit 120 includes a transmitting unit 121, a receiving unit 122, and a pair length measuring unit 123. The network error detection unit 130 includes a wiring error detection unit 131 and an error notification unit 132. The above described elements are implemented as a dedicated hardware line or a program to be executed by a processor.

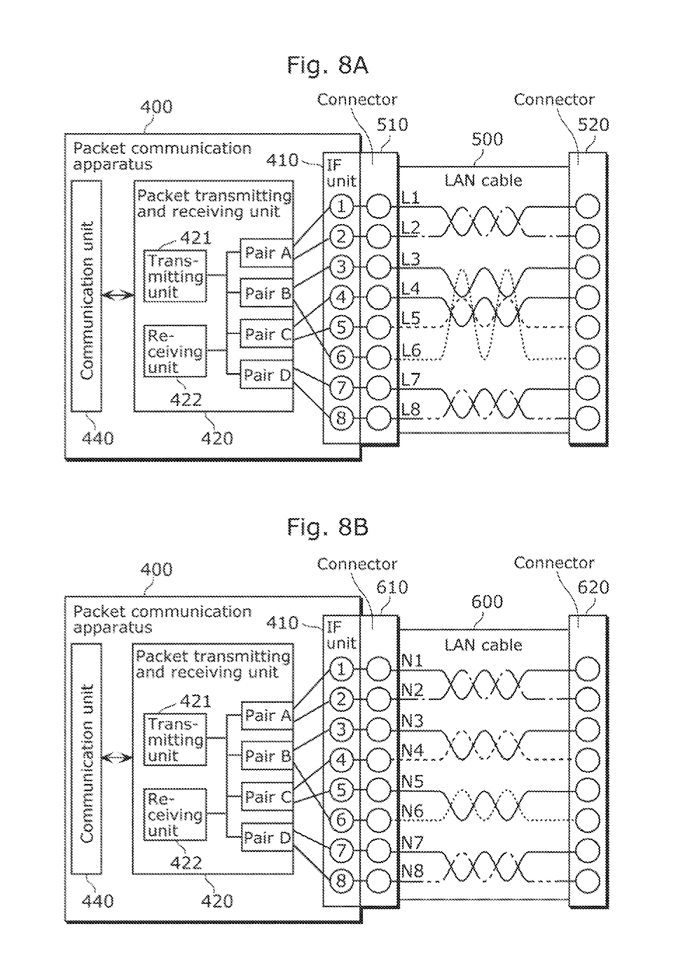

The LAN cable 200 includes a connector 210 and a connector 220 at the ends. More specifically, the LAN cable 200 includes a LAN cable body and two connectors. The IF unit 110 is connected to the connector 210 of the LAN cable 200. The packet communication apparatus 100 carries out packet communication with an external apparatus (not illustrated) via the LAN cable 200. It is to be noted that there is a case where the LAN cable 500 with correct wiring shown in FIG. 8A or the LAN cable 600 with erroneous wiring shown in FIG. 88 is used as the LAN cable 200 shown in FIG. 1.

The IF unit 100 can be connected to the connector 210 of the LAN cable 200. The IF unit 110 includes pins to connect to the connector 210. The number of the pins is the same as the number of pins of the connector 210 and is typically eight.

The transmitting unit 121 of the packet transmitting and receiving unit 120 transmits a packet inputted from the communication unit 140, via as the IF unit 110. In addition, the receiving unit 122 outputs, to the communication unit 140, the packet received via the IF unit 110. Furthermore, the pair length measuring unit 123 is an example of a measuring unit which obtains measured values by measuring a value that indicates a state of each set of the paired wires.

In Embodiment 1, the pair length measuring unit 123 measures the length of each set of the paired wires (hereinafter referred to also as pair length) in the LAN cable 200. It is to be noted that the function of measuring the pair length (distance measuring function) is held by many PHY chips.

The packet transmitting and receiving unit 120 performs physical connection that is positioned at the first layer of the OSI (open systems interconnection) reference model. More specifically, the packet transmitting and receiving unit 120 is a unit having a function of a PHY that specifies physical connection and transmission of a network. Since digital-analog conversion is performed in the PHY, a chip size to some extent is required. Accordingly, the PHY is often mounted as an individual external chip (PHY chip) instead of being included in a common chipset.

The wiring error detection unit 131 in the network error detection unit 130 is an example of an error information output unit that outputs error information indicating an error in the communication cable when the obtained measured values are substantially different.

In Embodiment 1, the wiring error detection unit 131 determines whether the LAN cable 200 connected to the IF unit 110 is a LAN cable with normal wiring or a LAN cable including a split pair. The wiring error detection unit 131 then notifies the error notification unit 132 of occurrence of an error when it is determined that the LAN cable 200 is a LAN cable including a split pair.

Upon receiving the notification of occurrence of an error in the LAN cable 200 from the wiring error detection unit 131, the error notification unit 132 notifies a user of the occurrence of an error. For example, the error notification unit 132 outputs an image or audio indicating the occurrence of an error, thereby notifying the user of the occurrence of an error.

The communication unit 140 performs packet communication through the packet transmitting and receiving unit 120 and the LAN cable 200.

FIG. 2 is a conceptual diagram which shows a connection state of the LAN cable 200 shown in FIG. 1. The IF unit 100 can be connected to the connector 210 of the LAN cable 200. More specifically, the eight pins of the IF unit 110 can be connected to the eight pins of the connector 210.

Here, the first pin and the second pin form the pair A. In addition, the third pin and the sixth pin form the pair B. Furthermore, the fourth pin and the fifth pin form the pair C. Furthermore, the seventh pin and the eighth pin form the pair D.

Pairing of the core wires in the LAN cable 200 is also determined by the paring of the pins. More specifically, a core wire M1 and a core wire M2 form the pair A. In addition, a core wire M3 and a core wire 6 form the pair B. Furthermore, a core wire M4 and a core wire 5 form the pair C. Furthermore, a core wire M7 and a core wire 8 form the pair D.

The pairs of the core wires determined as described above are called sets of paired wires. More specifically, each set of the paired wires includes two core wires determined according to the alignment of the core wires at the end of the LAN cable 200. In other words, each set of the paired wires includes two core wires determined according to the position of pins connected to the core wires.

The packet communication apparatus 100 measures the length of each set of the paired wires to detect an error of the LAN cable 200.

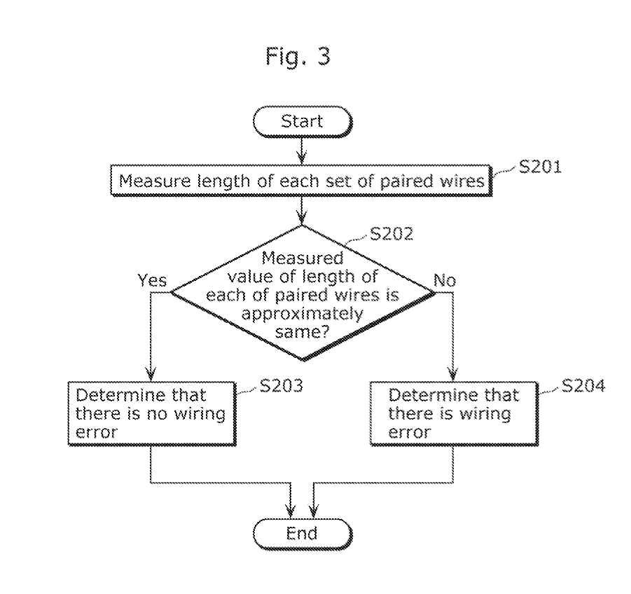

The following describes, with reference to FIG. 3, a flow of processing performed by the packet communication apparatus 100 shown in FIG. 1. It is to be noted that FIG. 3 is a flowchart which shows the flow of processing performed by the packet communication apparatus 100 shown in FIG. 1.

Here, each the phrases “substantially the same” and “substantially different” in Embodiment 1 will be explained in advance.

In Embodiment 1, the phrase “substantially the same” means that the difference between the maximum value and the minimum value among measured values of the length of plural sets of paired wires in the LAN cable is smaller than a threshold (predetermined value). In addition, the phrase “substantially different” means that the difference between the maximum value and the minimum value among the length of plural sets of paired wires is equal to or larger than the threshold.

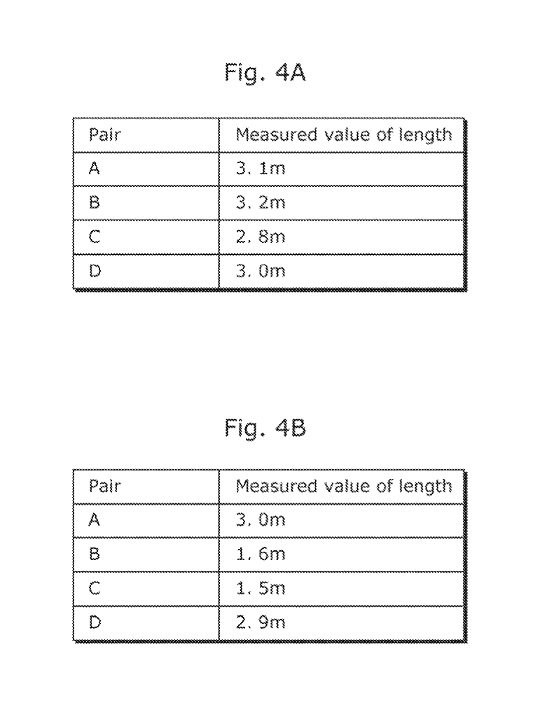

In addition, the phrases “substantially the same” and “substantially different” will be explained using a specific example of measurement results shown in FIG. 4A and FIG. 4B. FIG. 4A and FIG. 4B are diagrams each of which shows an example of the measurement result of the length of each set of the paired wires in the LAN cable. Here, it is a precondition that the threshold is 1.0 m.

When the measured value of the length of each set of the paired wires is as shown in the measurement result in FIG. 4A, the difference between the maximum value (3.2 m) and the minimum value (2.8 m) is 0.4 m. In this case, since the difference (0.4 m) is a value smaller than the threshold (1.0 m), the measured value of the length of each set of the paired wires is regarded as “substantially the same”.

On the other hand, when the measured value of the length of each set of the paired wires is as shown in the measurement result in FIG. 4B, the difference between the maximum value (3.0 m) and the minimum value (1.5 m) is 1.5 m. In this case, since the difference (1.5 m) is a value larger than the threshold (1.0 m), the measured value of the length of each set of the paired wires is regarded as “substantially different”.

The length of each set of the paired wires in the LAN cable is physically substantially the same as the length of the LAN cable. For this reason, when the length of each set of the paired wires is measured using the same measurement method, substantially the same measured value is supposed to be obtained. However, a LAN cable including a split pair has characteristics of being susceptible to noise. Therefore, the measured value of the length of each set of the paired wires is different from an actual length. Thus, when the measured value of the length of each set of the paired wires is not substantially the same, it is inferred that the LAN cable includes a split pair.

The function of measuring a distance of each set of the paired wires, which is held by a PHY chip, includes, for example, a system called time domain reflectometers (hereinafter referred to as TDR). With the TDR, an incident wave is transmitted to a LAN cable and the length of a set of paired wires is measured using a length of time from transmitting the incident wave to receiving a reflected wave of the incident wave.

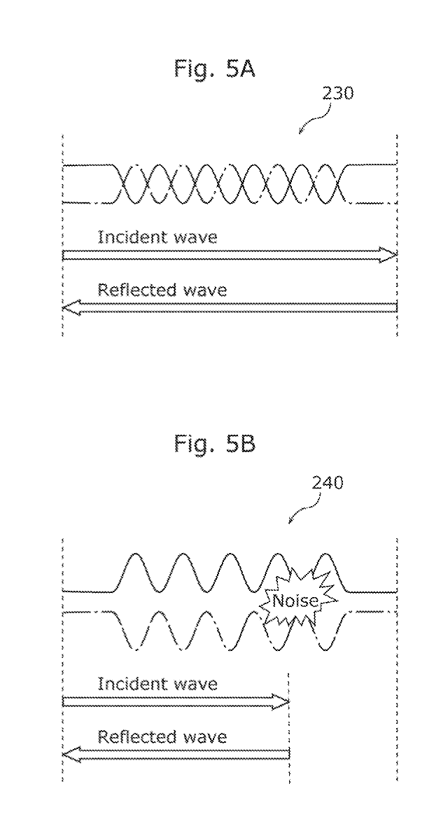

The following describes in more detail the measurement of the length of a set of paired wires with reference to FIG. 5A and FIG. 5B. FIG. 5A is a conceptual diagram which shows the measurement of a normal set of paired wires. FIG. 5B is a conceptual diagram which shows the measurement of an abnormal set of paired wires.

A set of paired wires 230 shown in FIG. 5A includes wires twisted together and is less likely to be affected by noise. An incident wave transmitted from one end of the set of paired wires 230 reaches the other end without being affected by noise. The incident wave that has reached the other end then returns as a reflected wave. In such a case where there is no noise effect, a measured value which indicates a correct length of the set of paired wires 230 can be obtained based on a length of time from transmitting the incident wave to receiving the reflected wave.

However, a set of paired wires 240 shown in FIG. 5B includes wires not twisted together and is likely to be affected by noise. An incident wave transmitted from one end of the set of paired wires 240 is in affected by noise and returns as a reflected wave before reaching the other end. In such a case where there is a noise effect, a measured value which indicates a correct length of the set of paired wires 240 cannot be obtained using a length of time from transmitting the incident wave to receiving the reflected wave. In the set of paired wires 240, the length of time from transmitting the incident wave to receiving the reflected wave becomes generally short. The measured value of the length of the set of paired wires 240 indicates a value shorter than an actual length.

Based on the assumption described above, the following describes the flow of processing shown in FIG. 3. First, the pair length measuring unit 123 of the packet transmitting and receiving unit 120 measures the length of each set of the paired wires in the LAN cable 200 using a predetermined measurement method (S201). The wiring error detection unit 131 of the network error detection unit 130 determines, based on the threshold, whether or not the measured value of the length of each set of the paired wires is substantially the same (S202).

In the example of the measurement result shown in FIG. 4A, the maximum value of the measurement result is 3.2 m and the minimum value among the measurement result is 2.8 m. The difference is 0.4 m.

When the threshold is 1.0 m, which is used for determining whether or not the measured value of the length of each set of the paired wires is substantially the same, and the measurement result shown in FIG. 4A is obtained, the difference (0.4 m) between the maximum value and the minimum value is smaller than the threshold (1.0 m). Therefore, the measured value of the length of each set of the paired wires is regarded as substantially the same. More specifically, the wiring error detection unit 131 determines that the LAN cable 200 is a LAN cable with normal wiring. It is to be noted that, such a threshold is determined based on a prior experiment and the like.

When the measured value of the length of each set of the paired wires measured in the measurement process (S201) is substantially the same (Yes in S202), the wiring error detection unit 131 determines that there is no wiring error in the LAN cable (S203). Then the packet communication apparatus 100 ends the processing.

On the other hand, when the measured value of the length of each set of the paired wires measured in the measurement process (S201) is substantially different (No in S202), the wiring error detection unit 131 determines that there is a wiring error in the LAN cable (S204). Then the packet communication apparatus 100 ends the processing.

It is to be noted that, in the measurement result shown in FIG. 4B, the maximum value of the measurement result is 3.0 m and the minimum value among the measurement result is 1.5 m. The difference is 1.5 m. Accordingly, the difference (1.5 m) between the maximum value and the minimum value is larger than the threshold (1.0 m). Therefore, the measured value of the length of each set of the paired wires is regarded as substantially different. More specifically, the wiring error detection unit 131 determines that the LAN cable 200 is a LAN cable with abnormal wiring (split pair).

The packet communication apparatus 100, even when the PHY chip does not have a crosstalk detection function, is capable of detecting a split pair through the processing described above, using the distance measuring function that is a function generally held by many PHY chips. Therefore, the packet communication apparatus 100 is capable of automatically detecting an error due to a split pair in the LAN cable and notifying a user accordingly. With this, the packet communication apparatus 100 can reduce troubles related to a network connection.

It is to be noted that, in Embodiment 1, the packet communication apparatus 100 that performs packet communication is described; however, the method of detecting a split pair may be applied to a communication apparatus that performs not only packet communication but also data communication.

In addition, the LAN cable 200 in which an error is detected has four sets of paired wires in Embodiment 1; however, the number of sets of paired wires is not limited to four, and may be two, three, or more than four.

In addition, although the wiring error detection unit 131 detects, as a split pair, that the measured value is substantially different, the wiring error detection unit 131 may detect that as an error of the communication cable. There is a high possibility that the split pair is the reason why the measured value is substantially different; however, other errors of a communication cable can also be the reason. Thus, the wiring error detection unit 131 does not have to limit the cause of an error to a split pair.

In addition, although the pair length measuring unit 123 measures the length of a set of paired wires, the pair length measuring unit 123 may measure a length of time from transmitting an incident wave to receiving a reflected wave. Alternatively, the pair length measuring unit 123, may measure a value that indicates another state of a sets of paired wires. Then the wiring error detection unit 131 determines whether or not the value measured by the pair length measuring unit 123 is substantially the same to detect a wiring error.

In addition, the packet transmitting and receiving unit 120 may transmit and receive a packet to and from the external apparatus through the IF unit 110 and the LAN cable 200 only when the measured value is substantially the same. With this, unstable communication is restricted and thus a trouble in communication is reduced.

In addition, in Embodiment 1, it is determined that the measured values are substantially the same in the case where the difference between the maximum value and the minimum value among the measured values is smaller than the threshold. However, the determination of whether or not the measured values are substantially the same is not limited to the determination method described above, and may be carried out by determining whether or not the difference between the measured values falls within a predetermined range. For example, the measured values may be determined as being substantially the same in the case where the difference between the maximum value and the minimum value among the measured values falls within the predetermined range.

### Embodiment 2

The packet communication apparatus 100 according to Embodiment 1 uses a value obtained from a prior experiment and the like, as a threshold for detecting a split pair; that is, a threshold used for determining whether or not measured values are substantially the same. Such a threshold is determined using a measurement error that occurs when the pair length measuring unit 123 measures a pair length. The wiring error detection unit 131, when the difference between measured values falls outside the range of the measurement error, determines that the measured values are substantially different and outputs error information.

The measurement error refers to the difference between the physical length of a set of paired wires and a measured value of the length of a set of paired wires measured by the pair length measuring unit 123 using a predetermined measurement method. In measurement of a pair length, the measurement error occurs even when the LAN cable 200 is normally wired. Furthermore, such a measurement error depends also on performance of the pair length measuring unit 123.

However, it is expected that an average value of measured values obtained by performing the measurement for several times becomes closer to the physical length of a set of paired wires, than a measured value obtained by performing the measurement only once. More specifically, since performing the measurement for several times reduces the effect of a temporally abnormal value, a measurement error is expected to be reduced. A packet communication apparatus according to Embodiment 2 increases accuracy, with use of such characteristics, in detecting a split pair.

It is to be noted that the packet communication apparatus according to Embodiment 2 is the same as the packet communication apparatus 100 according to Embodiment 1 shown in FIG. 1. Thus, the same numerals are used in the description below and the explanation for that is omitted here.

In addition, a flow of processing performed by the packet communication apparatus 100 according to Embodiment 2 is also the same as the flow of processing according to Embodiment 1 shown in FIG. 3 and thus the description for that is omitted here.

In Embodiment 2, the threshold for determining whether or not measured values are substantially the same is determined based on a measurement error in an average measured value of multiple measurements. Since the measurement error in the average measured value of multiple measurements becomes smaller, the threshold based on the multiple measurements is smaller than a threshold based on a single measurement.

In the case where the measurement error based on a single measurement is ±1.0 m, the range of the measurement error is 2.0 m. In Embodiment 1, for example, the range of the measurement error (2.0 m) is the threshold for detecting a split pair in the LAN cable 200; that is, the threshold used for determining whether or not the measured values are substantially the same.

The packet communication apparatus 100 according to Embodiment 1 determines whether or not measurement values are substantially the same using the threshold (2.0 m), based on the measurement result shown in FIG. 4B. The difference between the maximum value and the minimum value among the measurement result shown in FIG. 4B is 1.5 m. Therefore, when the threshold is 2.0 m, the measured value of the length of each set of the paired wires is regarded as substantially the same.

There is thus a possibility that the LAN cable 200 is erroneously determined as being wired normally without a split pair. More specifically, since the range of the measurement error is 2.0 m in this case, there is a possibility that the LAN cable 200 including a split pair is determined as not including a split pair.

In view of the above, the packet communication apparatus 100 according to Embodiment 2 uses not ±1.0 that is a measurement error based on a single measurement but ±0.5 that is a measurement error based on, for example, 10 measurements. Thus, it is assumed here that the measurement error in an average measured value based on 10 measurements is ±0.5. In this case, the range of the measurement error is 1.0 m. In other words, an increase in the number of measurements to ten measurements contributes to reduction in the threshold to 1.0 m which is used for determining whether or not measured values are substantially the same.

Then, the pair length measuring unit 123 according to Embodiment 2 measures a pair length ten times and calculates, for each set of the paired wires, an average value of results of the measurements. With the LAN cable 200 including a split pair, the measurement error is less likely to be reduced due to the effect of noise even when the pair length is measured several times. Therefore, a split pair is detected with higher accuracy, by comparing the average value calculated for each set of the paired wires with the reduced threshold.

It is to be noted that an average value of the results of measuring several times the LAN cable with correct wiring may be used for determination of a measurement error, based on the characteristics of variation in the measured values of the pair length, as described above. Alternatively, a mode or a median of such results of the measurement may be used.

When the measurement error determined as described above is used, the pair length measuring unit 123 measures the pair length several times and calculates an average value, a mode, or a median for each set of the paired wires. Then, the wiring error detection unit 131 determines whether or not the calculated average value, mode, or median falls within the range of the determined measurement error, thereby detecting a split pair.

In addition, when a parameter that affects the measurement error, such as a type of the communication cable, is set, a set value of the measurement error may be changed to change the threshold used for determining whether or not the measured values are substantially the same. In addition, there is a possibility that accuracy in measuring the pair length decreases during a normal packet communication. In view of the above, the packet communication apparatus 100 may measure the pair length for checking a split pair when not performing packet communication.

As described above, in Embodiment 2, a threshold is set which is used for determining whether or not the measured values are substantially the same, using the measurement error based on the number of measurements of the pair length. Furthermore, when a value of the measurement error is not sufficiently accurate, an accuracy of detecting a split pair can be improved by increasing the number of measurements.

It is to be noted that, in Embodiment 2, the threshold is set based on the number of measurements. However, the threshold may be a fixed value irrespective of the number of measurements. More specifically, the pair length measuring unit 123 may measure several times the value which indicates a length or state of each set of the paired wires even when the threshold is a fixed value.

In this case, the pair length measuring unit 123 calculates an average value, median, or mode of measurement results for each set of the paired wires, thereby obtaining measured values. The wiring error detection unit 131 determines whether or not the difference between the maximum value and the minimum value among the obtained measured values is equal to or larger than the threshold that is a fixed value, thereby detecting an error in the communication cable. With this, erroneous detection of an error in the communication cable due to a temporal abnormal value is reduced.

### Embodiment 3

A packet communication apparatus according to Embodiment 3 includes characteristic elements of the packet communication apparatus 100 according to Embodiment 1 or Embodiment 2.

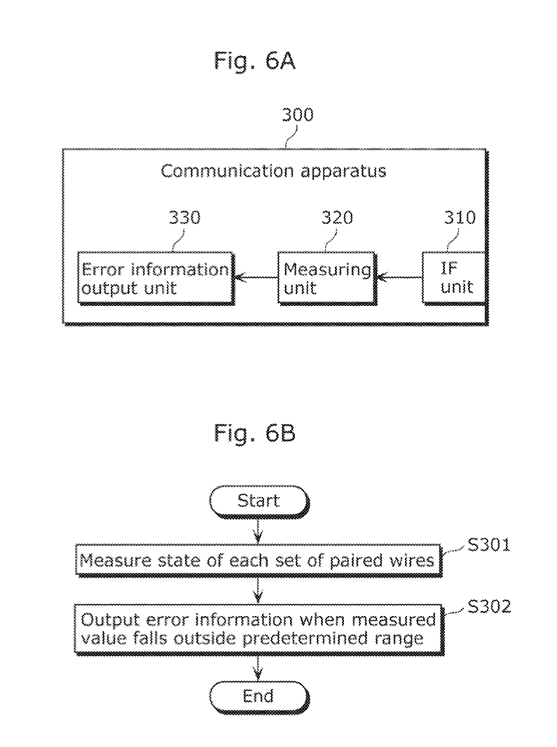

FIG. 6A is a configuration diagram which shows a communication apparatus according to Embodiment 3. A communication apparatus 300 shown in FIG. 6A includes an IF unit (interface unit) 310, a measuring unit 320, and an error information output unit 330. The IF unit 310 has the function same as the function of the IF unit 110 according to Embodiment 1 shown in FIG. 1. The measuring unit 320 has the function same as the function of the pair length measuring unit 123 according to Embodiment 1 shown in FIG. 1. The error information output unit 330 has the function same as the function of the wiring error detection unit 131 according to Embodiment 1 shown in FIG. 1.

The IF unit 310 can be connected to a communication cable such as the LAN cable 200 in the same manner as the IF unit 110 according to Embodiment 1 shown in FIG. 1. The communication cable includes plural sets of paired wires in the same manner as in Embodiment 1. For example, a connector is provided at the end of the communication cable, and pairing of core wires is determined based on a pin arrangement of the connector.

The measuring unit 320 measures a value which indicates a state of each set of the paired wires. More specifically, the measuring unit 320 measures, for each set of the paired wires, a value which indicates a state of the communication cable. With this, the measuring unit 320 obtains measured values. The measuring unit 320 may measure a length of each set of the paired wires or a length of time from transmitting an incident wave to receiving a reflected wave for each set of the paired wires. Alternatively, the measuring unit 320 may measure a value that indicates another state and is expected to be substantially the same in normal wiring.

The error information output unit 330, when the measured values obtained by the measuring unit 320 are substantially different, outputs error information indicating an error in the communication cable. The error information output unit 330 outputs error information when, for example, the difference between the measured values falls outside a predetermined range. In addition, the error information output unit 330 may output error information, at this time, to the error notification unit 132 shown in Embodiment 1.

FIG. 6B is a flowchart which shows a flow of processing performed by the communication apparatus 300 shown in FIG. 6A. First, the measuring unit 320 measures a value that indicates a state of each set of the paired wires included in the communication cable connected to the IF unit 310 (S301). With this, the measuring unit 320 obtains measured values. Next, the error information output unit 330, when the measured values obtained by the measuring unit 320 are substantially different, outputs error information. The error information output unit 330 outputs error information when, for example, the difference between the measured values falls outside a predetermined range (S302).

With this, the communication apparatus 300 can detect an error that is difficult to detect, in the communication cable.

### Embodiment 4

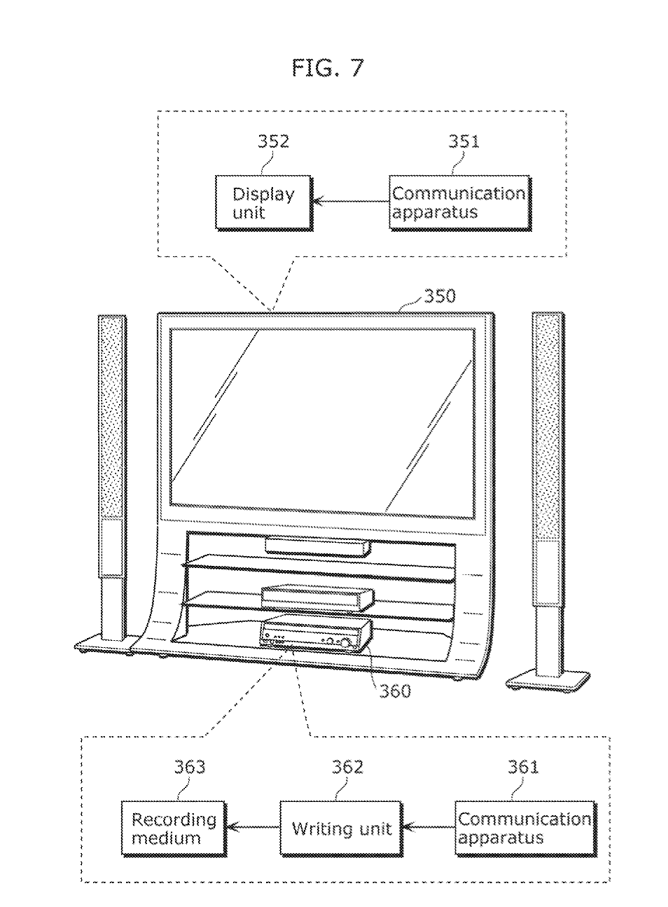

A television receiver and a video signal recording apparatus according to Embodiment 4 include the packet communication apparatus 100 or the communication apparatus 300 shown in the embodiments described above. FIG. 7 is a conceptual diagram which shows the television receiver and the video signal recording apparatus according to Embodiment 4.

The television receiver 350 shown in FIG. 7 is a television receiver connectable to a network and includes a communication apparatus 351 and a display unit 352. The communication apparatus 351 is the packet communication apparatus 100 described in Embodiments 1 and 2, or the communication apparatus 300 described in Embodiment 3. The communication apparatus 351 receives a video signal through a communication cable. The display unit 352 displays as a video, the video signal received by the communication apparatus 351.

With the configuration described above, the television receiver 350 can receive a video signal transmitted via an IP (internet protocol) broadcasting and the like and display, on the display unit 352, the received video signal as a video. In addition, the television receiver 350 may display, on the display unit 352, the error information outputted by the communication apparatus 351.

The video signal recording apparatus 360 shown in FIG. 7 is a video signal recording apparatus connectable to a network and includes a communication apparatus 361 and a writing unit 362. The video signal recording apparatus 360 is typically a video recorder. The communication apparatus 361 is the packet communication apparatus 100 described in Embodiments 1 and 2, or the communication apparatus 300 described in Embodiment 3. The communication apparatus 361 receives an image signal through a communication cable. The writing unit 362 writes the video signal received by the communication apparatus 361 into a recording medium 363.

The recording medium 363 may be a hard disc installed in the video signal recording apparatus 360 or a BD (Blu-ray Disc) that is removable from the video signal recording apparatus 360.

With the configuration described above, the video signal recording apparatus 360 can receive a video signal transmitted through IP broadcasting and the like and write the received video signal into the recording medium 363.

The communication apparatus according to the present invention has been described above based on the several embodiments; however, the present invention is not limited to these embodiments. Other forms in which various modifications apparent to those skilled in the art are applied to the embodiment, or forms structured by combining elements of different embodiments are included within the scope of the present invention.

For example, processes performed by a specific processing unit may be performed by another processing unit. In addition, the order in which the processes are performed may be changed or different processes may be performed in parallel.

In addition, the present invention can be implemented not only as a communication apparatus but also as a method that implements the various processing units of which the communication apparatus is configured as steps. Furthermore, the present invention can also be realized as a program which causes a computer, or a program which causes a communication apparatus that performs communication using a communication cable, to execute these steps included in the method. Furthermore, the present invention can be realized as a computer readable recording medium on which the program is recorded, such as a CD-ROM.

In addition, the elements included in the communication apparatus may be implemented as an LSI (Large Scale Integration) which is an integrated circuit. These elements can be integrated separately, or a part or all of them can be integrated into a single chip. For example, only the error information output unit 330 may be mounted as an LSI to be incorporated in the communication apparatus. The LSI here can be referred to as an IC (integrated circuit), a system LSI, a super LSI, or an ultra LSI, depending on the degree of integration.

In addition, an integrated circuit used for such an embodiment is not limited to an LSI, and it may be embodied as a dedicated circuit or a general-purpose processor. It is also possible to use an FPGA (field programmable gate array) which can be programmed in the field, or a reconfigurable processor in which connection and setting of circuit cells inside an LSI can be reconfigured.

Furthermore, when a technology for the integrated circuit replacing LSI is developed with the advance of semiconductor technology or relevant technology, elements included in the communication apparatus can be integrated into a circuit using the technology.

### INDUSTRIAL APPLICABILITY

The present invention is applicable mainly to home appliances such as a television receiver that performs communication using a communication cable, and widely applicable to communication apparatuses that perform communication using a communication cable.

### REFERENCE SIGNS LIST

100, 400 packet communication apparatus
110, 310, 410 IF unit (interface unit)
120, 420 packet transmitting and receiving unit
121, 421 transmitting unit
122, 422 receiving unit
123 pair length measuring unit
130 network error detection unit
131 wiring error detection unit
132 error notification unit
140, 440 communication unit
200, 500, 600 LAN cable
210, 220, 510, 520, 610, 620 connector
230, 240 set of paired wires
300, 351, 361 communication apparatus
320 measuring unit
330 error information output unit
350 television receiver
352 display unit
360 video signal recording apparatus
362 writing unit
363 recording medium

1. A communication apparatus for communication using a communication cable including plural sets of paired wires, said communication apparatus comprising:
an interface unit connectable to the communication cable;
a measuring unit configured to measure a value indicating a state of each set of the paired wires included in the communication cable connected to said interface unit, to obtain measured values; and
an error information output unit configured to output error information indicating an error in the communication cable when the measured values obtained by said measuring unit are substantially different.

2. The communication apparatus according to claim 1, further comprising
a packet transmitting and receiving unit configured to transmit and receive a packet via said interface unit,
wherein said measuring unit is included in said packet transmitting and receiving unit.

3. The communication apparatus according to claim 1,
wherein said measuring unit is configured to measure, as the value indicating the state, a value indicating a length of each set of the paired wires, to obtain the measured values.

4. The communication apparatus according to claim 1,
wherein said measuring unit is configured to measure, as the value indicating the state, a value indicating a length of time from transmitting an incident wave to receiving a reflected wave, for each set of the paired wires, to obtain the measured values.

5. The communication apparatus according to claim 1,
wherein, when the measured values obtained by said measuring unit are substantially different, said error information output unit is configured to output the error information indicating that the communication cable includes a split pair which is an erroneous wiring in which paired wires that need to be twisted together are not twisted together.

6. The communication apparatus according to claim 1,
wherein said error information output unit is configured to output the error information when a difference between the measured values obtained by said measuring unit falls outside a range of a measurement error of said measuring unit.

7. The communication apparatus according to claim 1,
wherein said measuring unit is configured to measure more than once the value indicating the state and calculate one of an average value, a median, and a mode of measurement results for each set of the paired wires, to obtain the measured values.

8. The communication apparatus according to claim 2,
wherein said packet transmitting and receiving unit is configured to transmit and receive a packet to and from an external apparatus via said interface unit when the measured values obtained by said measuring unit are substantially the same.

9. The communication apparatus according to claim 1,
wherein said error information output unit is configured to output the error information when a difference or a ratio between a maximum value and a minimum value among the measured values obtained by said measuring unit falls outside a predetermined range.

10. A television receiver connectable to a network, comprising:
said communication apparatus according to claim 1; and
a display unit configured to display a video signal received by said communication apparatus.

11. A video signal recording apparatus connectable to a network, comprising:
said communication apparatus according to claim 1; and
a writing unit configured to write onto a recording medium, a video signal received by said communication apparatus.

12. A communication method for communication using a communication cable performed by a communication apparatus including an interface unit connectable to the communication cable including plural sets of paired wires, said communication method comprising:
measuring a value indicating a state of each set of the paired wires included in the communication cable connected to the interface unit, to obtain measured values; and
outputting error information indicating an error in the communication cable when the measured values obtained in said measuring are substantially different.

13. A non-transitory computer-readable recording medium on which a program is recorded, the program causing a communication apparatus including an interface unit connectable to a communication cable including plural sets of paired wires, to execute:
measuring a value indicating a state of each set of the paired wires included in the communication cable connected to the interface unit, to obtain measured values; and
outputting error information indicating an error in the communication cable when the measured values obtained in said measuring are substantially different.

14. An integrated circuit mounted on a communication apparatus including an interface unit connectable to a communication cable that includes plural sets of paired wires and a measuring unit that measures a value indicating a state of each set of the paired wires included in the communication cable connected to the interface unit, to obtain measured values; said integrated circuit comprising
an error information output unit configured to output error information indicating an error in the communication cable when the measured values obtained by the measuring unit are substantially different.
